(19) United States
(12) Patent Application Publication
(10) Pub. No.: US 2015/0110166 A1
(43) Pub. Date: Apr. 23, 2015

(54) Mechanics and Processes for Remote Control of Live Video Production

(71) Applicant: PALADIN INNOVATORS, FEDERAL WAY, WA (US)

(72) Inventors: DEAN BISOGNO, FORT COLLINS, CO (US); JOSHUA SNIFFEN, BILOXI, MS (US); THOMAS CURRAN, FEDERAL WAY, WA (US)

(21) Appl. No.: 14/060,838

(22) Filed: Oct. 23, 2013

(51) Int. Cl. H04N 19/162; H04H 60/04

(52) U.S. Cl. CPC H04N 19/162; H04H 60/04
USPC 375/240.01

(57) ABSTRACT

Mechanics and processes for remote control of live video production are disclosed herein. Producing a live, online video currently requires having direct control of the encoding system. The essential practice of the mechanics and processes is the design of a web service allowing encoder functionality to be controlled remotely, via a web interface or mobile device application (a.k.a. app).

### PRIORITY CLAIM

The present application claims priority from and the benefit of U.S. Provisional Application No. 61/717,485 filed on Oct. 23, 2012 which is herein incorporated by reference.

### DETAILED DESCRIPTION OF THE PREFERRED EMBODIMENT

### Remote Production Methods

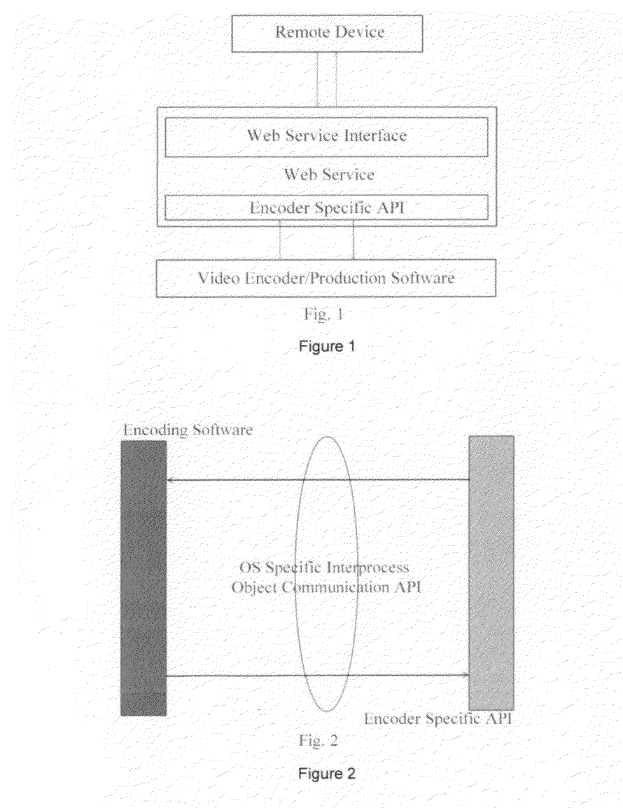

FIG. 1 describes the architecture of the system and overall method of practice.

Users will supply their own remote device, it could be any device with an HTML 5 capable web browser or a device for which we develop a device specific application. They will use their device to visit the hosted Web Service Interface which is provided by the Remote Production Web Service hosted on the Remote Production Server. The Web Service operates the encoding/production software through an encoder specific API, written to abstract the encoder/producer functionality in such a way that the web service can translate user actions into an appropriate operation for the encoder software.

### Encoder Specific API

Creating an encoder specific API requires utilizing operating system level object communication libraries to interact with the encoding/production software. On the Microsoft Windows platform this is the COM/OLE/Automation API and Libraries, on the Mac platform it is Applescript. FIG. 2 illustrates the relationship between the Encoder Specific API, the inter-process object communication API and the encoder/production software.

The encoder specific API works by translating a web service request into an action taken against the encoding software through the inter-process object communication API.

### Web Service Interface for Remote Production of a Live Video Stream

Successfully controlling the production of a live video stream over a remote connection requires a uniquely designed interface. The interface should place priority on the monitoring of current streams and allow for easy switching of pre-composed shots from a queue. The interface must then translate user actions into a lightweight (REST or SOAP) message for transmission to the server via HTTP 1.1.

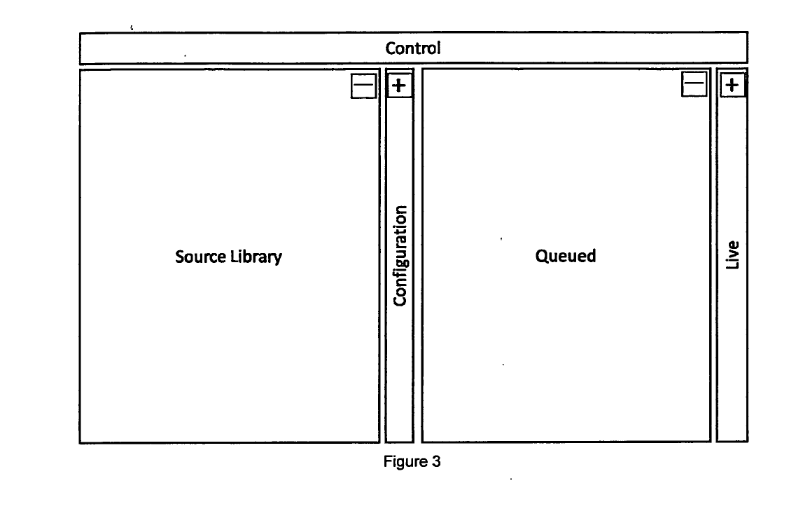

FIG. 3 illustrates one instantiation of this design. It is composed of sections dedicated to 1) a media library 2) streaming configuration 3) a queued shot 4) a preview of the live stream. Users can use a mouse or touchscreen to control the application.

While the preferred embodiment has been illustrated and described, as noted above, many changes can be made without departing from the spirit and scope of the invention. Accordingly the scope of the invention is not limited by the disclosure of the preferred embodiment.

The embodiments of the invention in which an exclusive property or privilege is claimed are defined as follows:

1. A system which allows for remote production of live video either over the internet or through a LAN. Comprised of a remote device, specialized web service, and video encoder/production software.

2. An encoding API which translates web service requests into actions targeting a separate encoding/production process.

3. A user interface which translates user actions into messages for transmission via HTTP 1.1 to a web service which controls a piece of video encoding/production software.
